(19) United States
(12) Patent Application Publication
(10) Pub. No.: US 2023/0090339 A1
(43) Pub. Date: Mar. 23, 2023

(54) KICKSTAND FOR A SMART DEVICE

(71) Applicant: Travis Rieger, Bismarck, ND (US)

(72) Inventor: Travis Rieger, Bismarck, ND (US)

(21) Appl. No.: 17/932,745

(22) Filed: Sep. 16, 2022

Related U.S. Application Data
(60) Provisional application No. 63/245,293, filed on Sep. 17, 2021.

(51) Int. Cl. H04M 1/12; H04M 1/04; F16M 11/04

(52) U.S. Cl. CPC H04M 1/12; H04M 1/04; F16M 11/04

(57) ABSTRACT

A kickstand for a smart device to prop up the smart device on a surface includes a magnet attached to a body for magnetic attachment to the smart device.

The present disclosure claims priority to U.S. Provisional Patent Disclosure Ser. No. 63/245,293 filed Sep. 17, 2021.

### FIELD OF TECHNOLOGY

This disclosure generally relates to cases for holding smart devices, such as cell phones.

### BACKGROUND

Cell phones have been commonly used for functions including calling, texting, video-conferencing, video viewing, media streaming, internet browsing, photography, and other such functions in recent years. Cell phones have grown far beyond the traditional phone call function and are often now referred to as smart devices. Many devices have been developed to hold smart devices in various manners depending on the desired application.

When a smart device is used to view a video, a user might want to have the device held in a horizontal or landscape orientation on a surface. Alternatively, if a person wishes to read content from a website or a notepad, the user might want the smart device to be held in a vertical or portrait orientation. User traditionally have propped the smart device up against another object such as a cup. Many users choose not to attach an object to the back of their smart device as they do not want to be annoyed or hindered by the attached object.

### SUMMARY

A kickstand for a smart device to prop up the smart device on a surface according to one disclosed non-limiting embodiment of the present disclosure includes a magnet attached to the body for magnetic attachment to the smart device.

A further embodiment of any of the foregoing embodiments of the present disclosure includes that the magnet is encapsulated within the body.

A further embodiment of any of the foregoing embodiments of the present disclosure includes that the magnet is molded into the body.

A further embodiment of any of the foregoing embodiments of the present disclosure includes that the body is manufactured of a non-metallic material,

A further embodiment of any of the foregoing embodiments of the present disclosure includes that the body is manufactured of a non-magnetic material.

A further embodiment of any of the foregoing embodiments of the present disclosure includes that the body is generally triangular in shape.

A further embodiment of any of the foregoing embodiments of the present disclosure includes that the body further comprises a curved portion between a stand leg portion and a base portion, the base portion being that which contacts the smart device.

A further embodiment of any of the foregoing embodiments of the present disclosure includes that the magnet is configured to be adjacent to the base portion.

A further embodiment of any of the foregoing embodiments of the present disclosure includes that the stand leg portion is curved.

A further embodiment of any of the foregoing embodiments of the present disclosure includes a hinge such that the body is transformable between an open and a closed configuration.

A further embodiment of any of the foregoing embodiments of the present disclosure includes that the magnet is magnetically attachable to a connection pad of the smart device.

A further embodiment of any of the foregoing embodiments of the present disclosure includes that the connection pad is a wireless charging device that is integral with the smart device.

A kickstand for a smart device having a connection pad according to one disclosed non-limiting embodiment of the present disclosure includes a base portion; a stand leg portion; a curved portion between the stand leg portion and the base portion; and a magnet adjacent to the base portion for magnetic attachment to the connection pad.

A further embodiment of any of the foregoing embodiments of the present disclosure includes that the connection pad is a wireless charging device that is integral with the smart device.

A further embodiment of any of the foregoing embodiments of the present disclosure includes that the base portion, the stand leg portion and the curved portion form a triangular body.

A further embodiment of any of the foregoing embodiments of the present disclosure includes that the magnet is encapsulated within the body.

A further embodiment of any of the foregoing embodiments of the present disclosure includes that the magnet is molded into the body.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a back view of a smart device with a kickstand in accords with a first embodiment.

FIG. 2 is a side profile view of a smart device with a kickstand of FIG. 1 in the closed position.

FIG. 3 is a side view of the smart device with the kickstand of FIG. 1 in the open position as a first embodiment.

FIG. 4 is a perspective view of a smart device displayed in the portrait orientation with a kickstand in the open position as a second embodiment.

FIG. 5 is a perspective view of a smart device displayed in the landscape orientation with the kickstand of FIG. 4 in the open position as the second embodiment.

FIG. 6A is a perspective view of another embodiment of the kickstand attached to the back of a smart device displayed in the portrait orientation.

FIG. 6B-6H are perspective views of the embodiment of the kickstand of FIG. 6A.

FIG. 7A-7G are perspective views of another embodiment of the kickstand.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### DETAILED DESCRIPTION

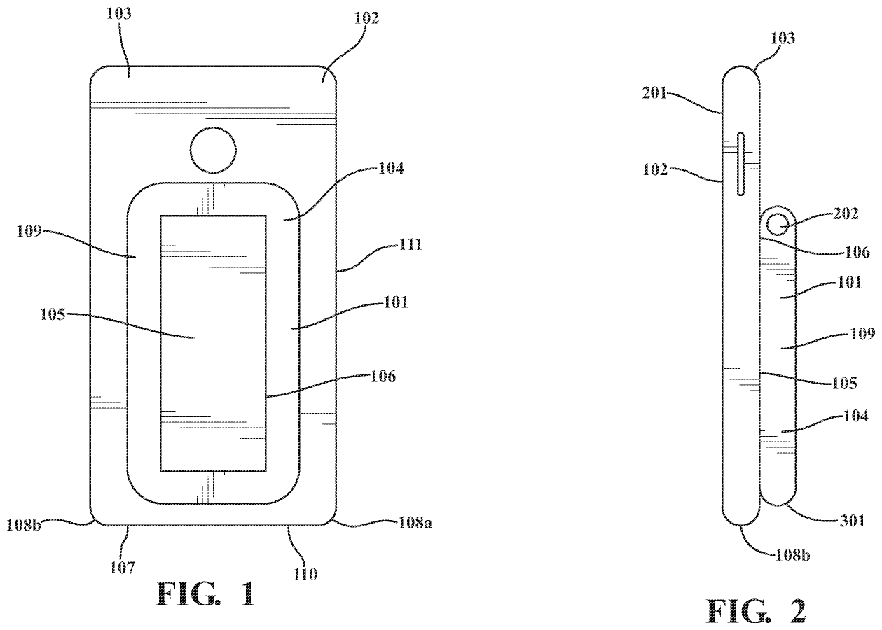

FIG. 1 is a view of the back 103 of the smart device 102 with a kickstand 101 as the first embodiment. The smart device 102 may be an electronic gadget capable of displaying information to a user on a screen 201. The smart device 102 includes but is not limited to phones, tablets, personal computers, phablets, e-readers, and other such devices. The smart device 102 has a back 103, a screen 201, and sides. The kickstand 101 may be magnetically positioned against the back 103 of the smart device 102 when the kickstand 101 is used to hold a smart device 102.

The kickstand includes a body 104, a magnet 105, and a connection pad 106. The body 104, when attached to the smart device 102, and while in an open position, may be configured to extend away from the back 103 of the smart device 102. When the body 104 is extending away from the back 103 of the smart device 102 the shape of the smart device 102 and the body 104 cause the smart device 102 to be propped up on the surface upon which the smart device 102 is placed. The body 104 is configured to hold the smart device 102 above the surface only when the user positions the base 107 and the body 104 against the surface. The base 107 may be positioned on the surface such that both a first corner 108a and second corner 108b of the smart device 102 are touching the surface. The first corner 108a and the second corner 108b are herein referred to as the corners 108. The corners 108 of the smart device 102 may refer to the corners of the bottom 110 of the smart device 102 when placed in the portrait orientation, or may refer to the corners of the side 111 of the smart device 102 when placed in the landscape orientation. In other words, if the phone is placed on the screen 201, the kickstand 101 is not being used to prop the device on the surface.

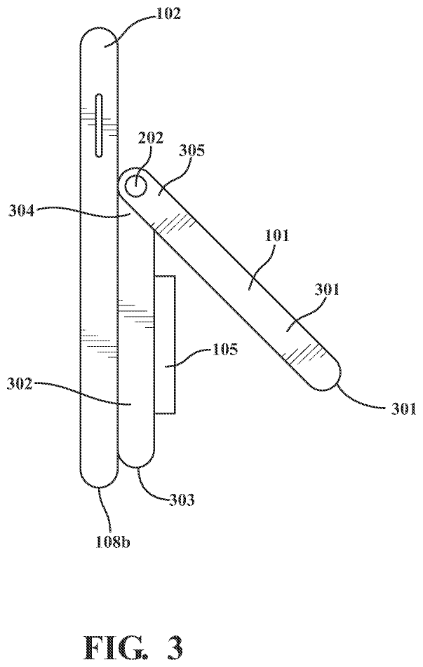

The body 104 of the kickstand 101 may be configured in various embodiments. In FIG. 1-3 the body 104 is configured such that the user may place the body 104 in either a closed position or an open position. The closed position is shown in FIG. 2 whereas the open position is shown in FIG. 3.

The body 104 of the kickstand 101 includes a magnet 105 and a movable structure 109. The movable structure 109 may be the portion of the body 104 that can extend away from the back 103 of the smart device 102. The screen 201 is located on the opposite side of the back 103 of the smart device 102.

The movable structure 109 may be attached to the magnet 105. The magnet 105 may be placed adjacent to the connection pad 106 when a user wants to use the kickstand 101 to prop up the smart device 102. When the magnet 105 may be placed adjacent to the connection pad 106, magnetic force causes the magnet 105 to be secured to the connection pad 106. The body 104 of the kickstand 101 may be magnetically secured to the connection pad 106, which is secured to the back 103 of the smart device 102.

The connection pad 106 may be a piece of steel, a magnet, or any other magnetically attractable material. A layer of material may be located between the connection pad 106 and the magnet 105. For example, the connection pad 106 may be configured to be within a phone case or within the smart device 102 itself. The phone case could be located between the connection pad 106 and the location where the kickstand 101 secures to the smart device 102. For example, the magnet 105 may be molded into the body 104 such that there may be a layer of plastic or other material between the magnet 105 and the external surface of the body 104. Another embodiment of the connection pad 106 may be a connection pad 106 which may be attached to the back 103 of the smart device 102 using an adhesive. Another embodiment of the connection pad 106 may be a wireless charging device that may be integral with the smart device 102. The wireless charging device typically includes materials which permit a magnet such as that within a magnetic charger pad to magnetically attach.

In the embodiment of FIG. 1-3, the body 104 may include a hinge 202. Opposite of the hinge 202 is the stand leg portion 301 of the movable structure 109. The stand leg portion 301 of the movable structure 109 may be placed against the surface upon which the smart device 102 is placed upon, when a user is using the kickstand 101 to hold the smart device 102. The hinge 202 allows the movable structure 109 of the body 104 to transform from an open position to a closed position. As shown in FIG. 2, the body 104 is in the closed position. When the body 104 is in the closed position, the user is not using the kickstand 101 to hold the smart device 102. The closed position is when the movable structure 109 of the body 104 is transformed such that the stand leg portion 301 of the movable structure 109 is adjacent to the back 103 of the smart device 102.

With reference to FIG. 3 a side profile of the smart device 102 with the kickstand 101 in the open position is illustrated in one embodiment. The movable structure 109 in this embodiment as shown in FIG. 1-3 includes a stand leg portion 301 and a base portion 302. The base portion 302 has a hinge end portion 304 and a base portion end 303. The hinge end portion 304 is attached to the hinge 202. The stand leg portion 301 has a base end 305 which is distal to the stand leg portion 301. The base end 305 is also attached to the hinge 202.

When the stand leg portion 301 is transformed to the closed position, the stand leg portion 301 may be secured in place using the magnet 105 or may use a second magnet configured for such purpose. When the body 104 is in the open position, the stand leg portion 301 is hingedly rotated along the axis of the hinge 202 such that the stand leg portion 301 of the stand leg portion 301 may be rotated away from the base portion end 303. The hinge 202 may be configured to rotate a limited distance. The maximum rotation allowed may be such that both the stand leg portion 301 and the base 107 may touch the surface upon which a user employs the kickstand 101 to hold a smart device 102.

The connection pad 106 may extend from a pad top 401 to a pad bottom 402 and from a pad left side 403 to a pad right side 404. Although a rectilinear connection pad 106 is disclosed in the illustrated embodiment, other shapes and sizes of connections pad will benefit herefrom. The body 104 may be magnetically attached at any angle and at any location upon the connection pad 106. The user may position the body 104 at various locations on the connection pad 106 to achieve different holding positions at which the smart device 102 is held in relation to the surface upon which the user places the kickstand 101.

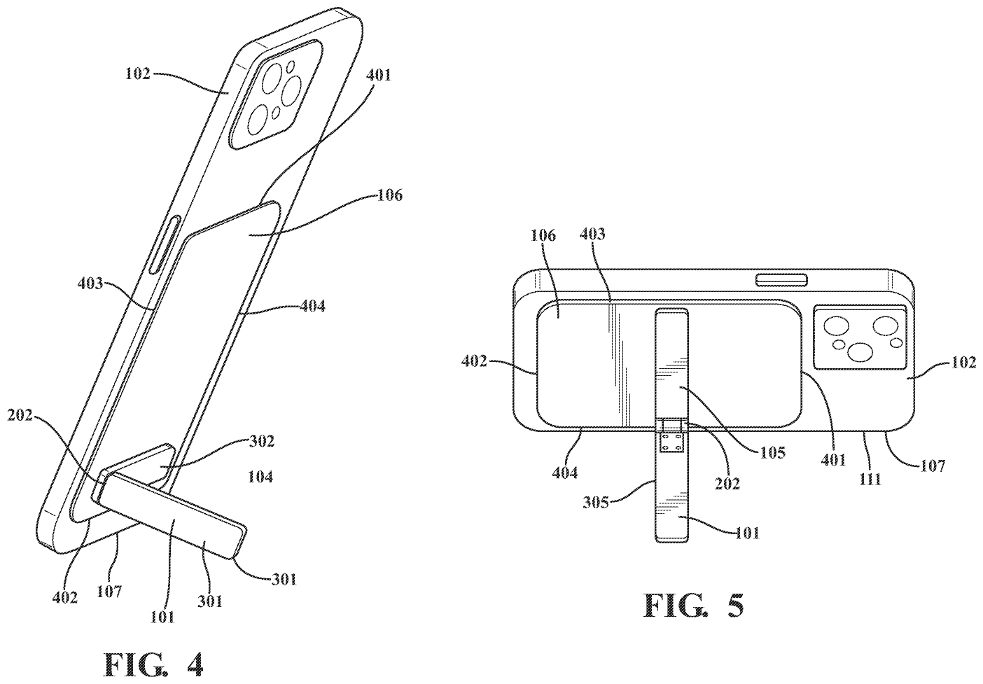

With reference to FIG. 4, a perspective view of the smart device 102 is displayed in the portrait orientation with the kickstand 101. The hinge 202 may be positioned perpendicularly to the surface upon which a user uses the kickstand 101 to hold the smart device 102. The stand leg portion 301 in this embodiment may be distally located in relation to the hinge 202.

With reference to FIG. 5, a perspective view of the smart device 102 is displayed in the landscape orientation with the kickstand 101. The hinge 202 may be positioned parallel to the surface upon which the smart device 102 is placed. When the smart device 102 is in the landscape orientation, the base 107 is on the side 111 of the smart device 102 which is positioned against the surface. The stand leg portion 301 as shown in FIG. 5 is located distally to the hinge 202 and the base end 305. The magnet 105 is attached to the body 104 such that the body 104 is magnetically secured to the connection pad 106.

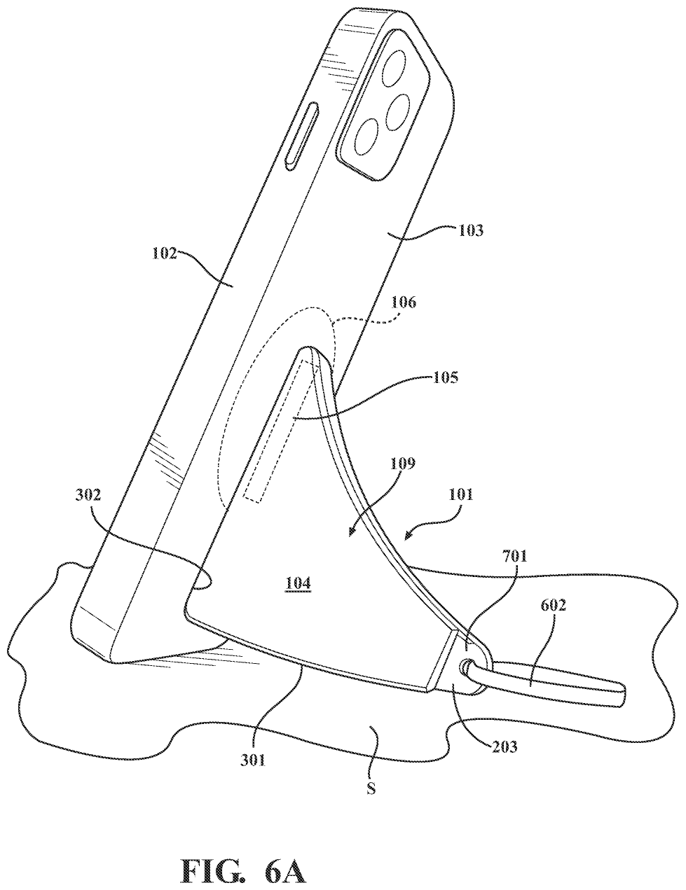

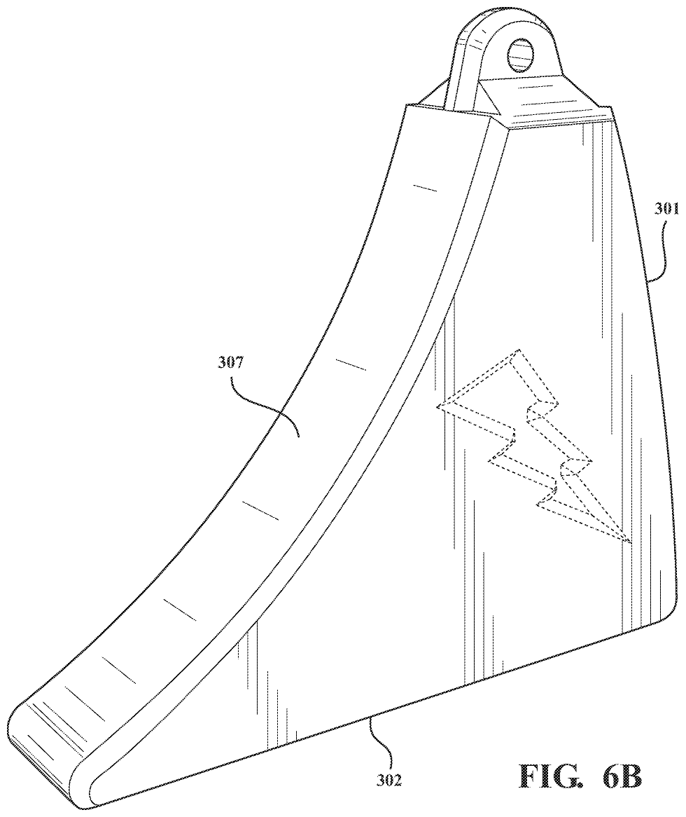

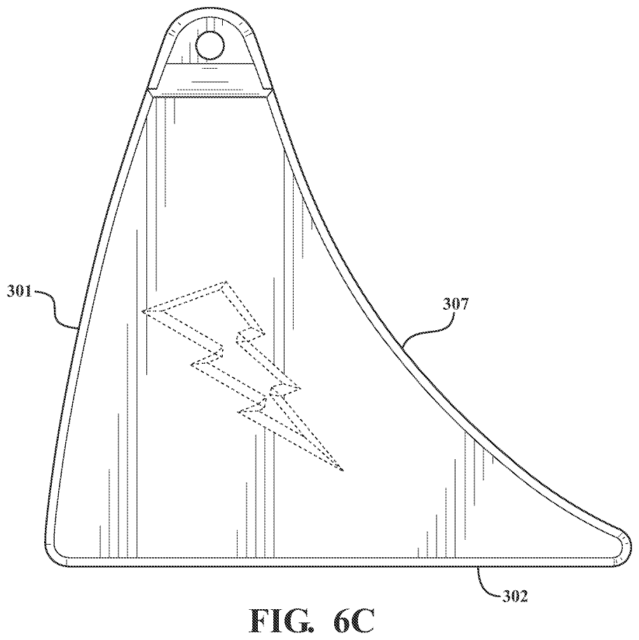

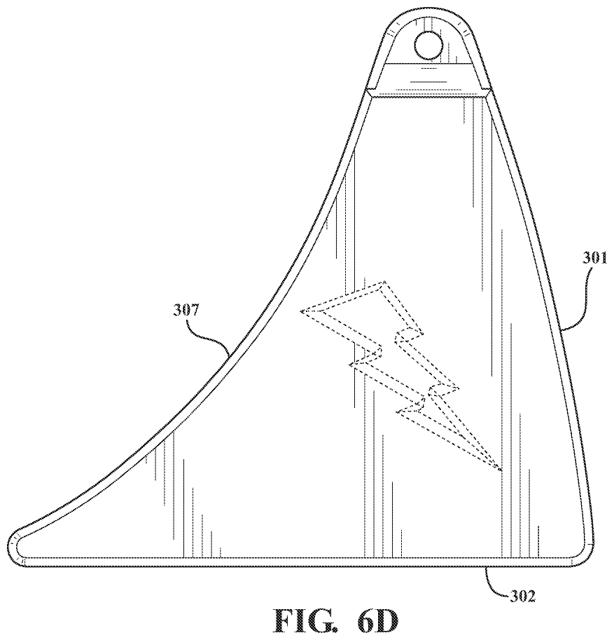

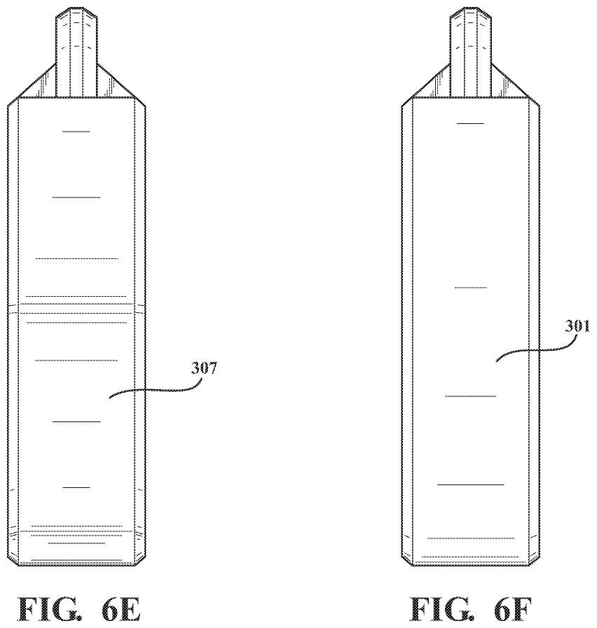

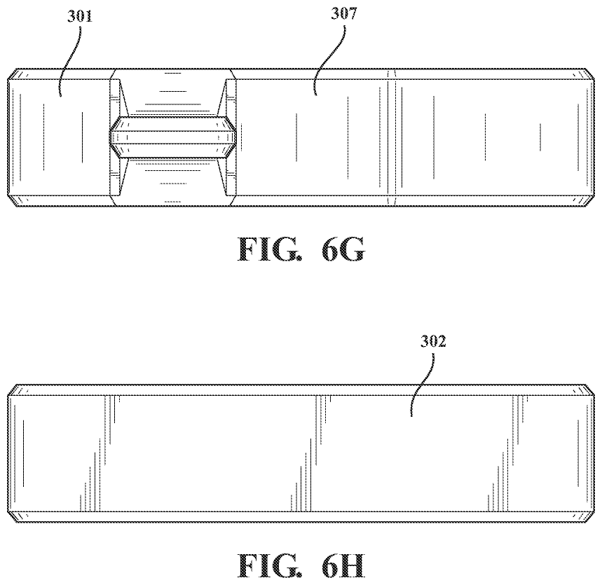

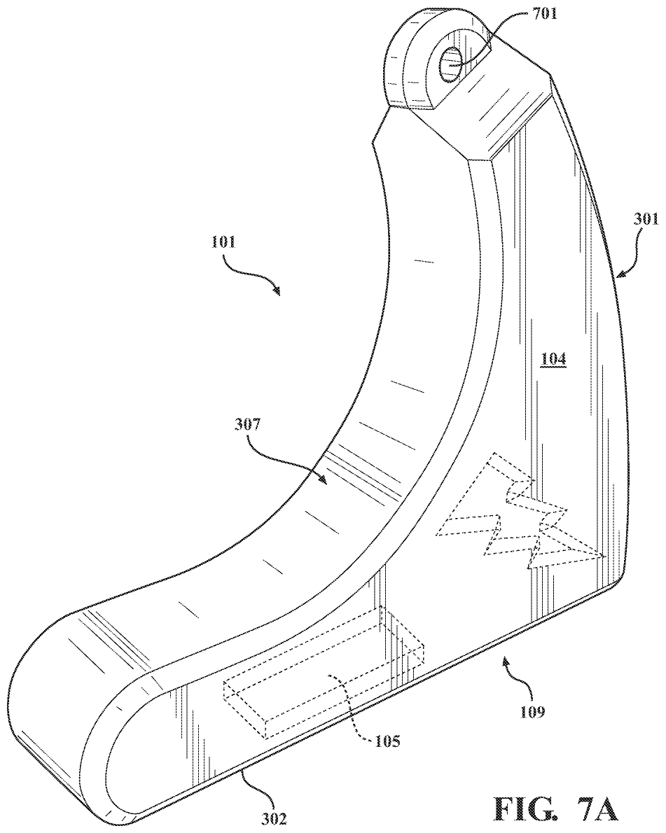

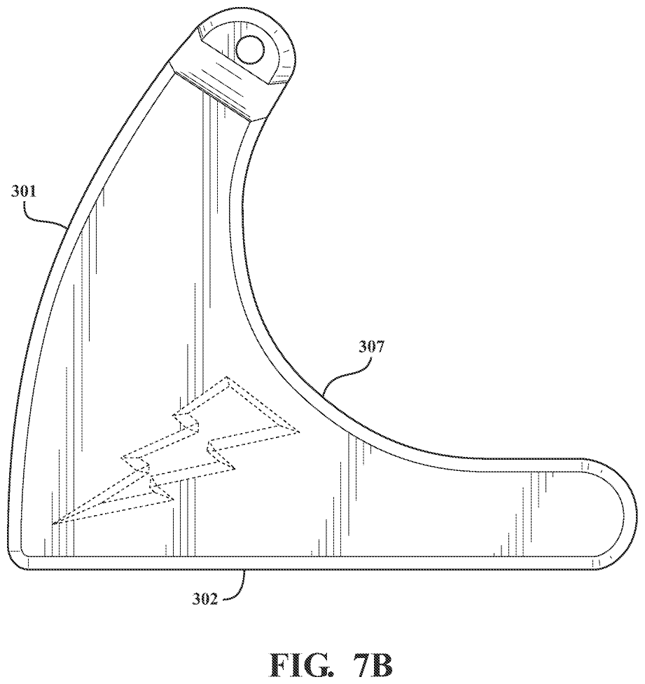

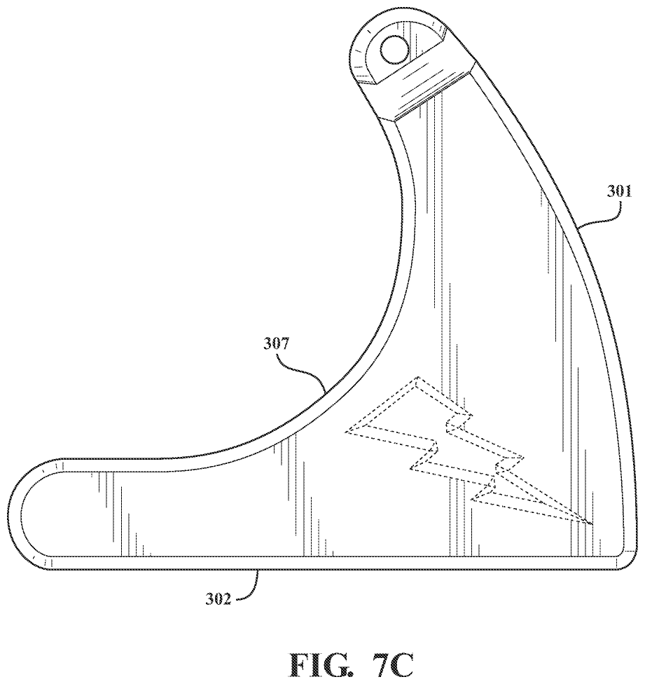

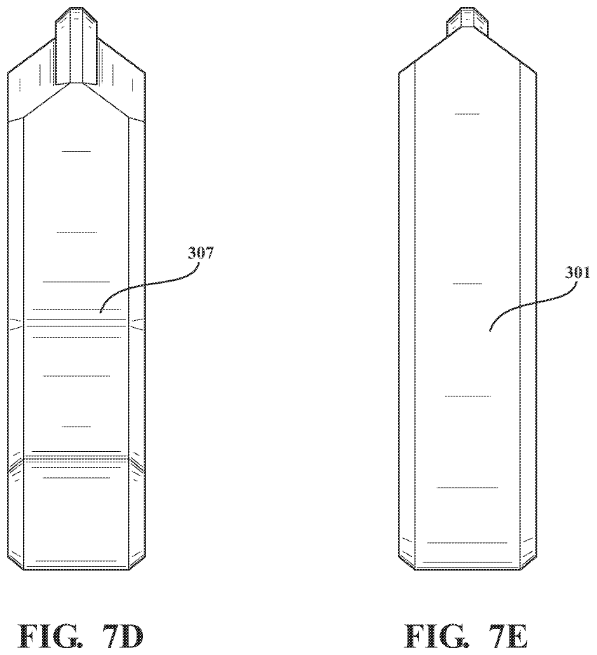

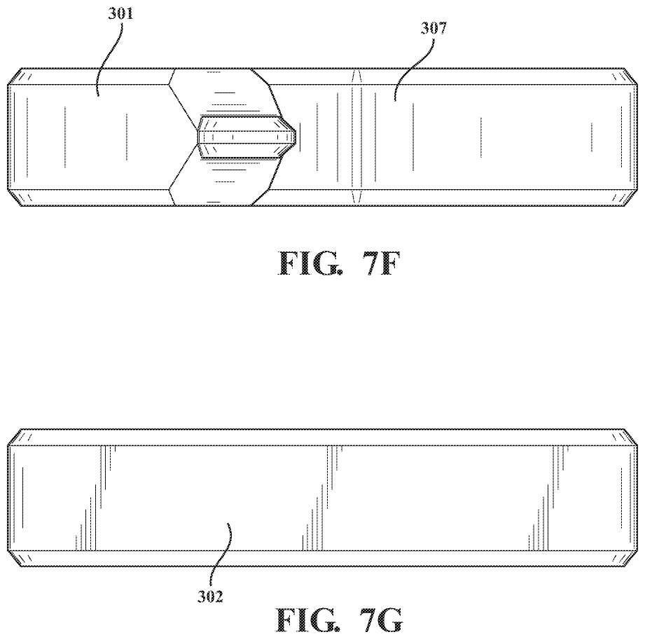

With reference to FIG. 6A, another embodiment of the kickstand 101 is attached to the back 103 of the smart device 102. FIGS. 6A-6H and 7A-7G are different embodiments of a single unitary kickstand 101 readily attachable to a keychain or other lanyard. The smart device 102 and kickstand 101 as shown in FIG. 6A is placed upon a surface S. The body 104 is magnetically attached to the smart device 102 such that the smart device 102 may be positioned in a portrait or vertical orientation in relation to the surface S.

The body 104 in the embodiments shown in FIGS. 6A-6H and 7A-7G contain a magnet 105. The magnet 105 may be molded into the body 104. The magnet 105 may be positioned within the body 104 such that it may be adjacent to the exterior face of the body 104 which may be adjacent to the smart device 102. The stand leg portion 301 of the movable structure 109 in this embodiment may be distally located in relation to the location of the magnet 105. A key ring 602 may be attached to the body 104. The body 104 may be carried independently of the smart device 102. When it is desired by the user to employ the kickstand 101, the body 104 may be magnetically and removably secured to the connection pad 106 on the smart device 102.

FIG. 7A-7G are various views of another embodiment of the kickstand 101. The body 104 includes a movable structure 109 and a magnet 105. The magnet 105 may be molded into the movable structure 109 of the body 104. A key ring hole 701 may be located near the stand leg portion 301 of the movable structure 109. The base portion 302 of the movable structure 109 may be where the magnet 105 may be configured. The stand leg portion 301 of the movable structure 109 may be where the stand leg portion 301 may be configured. This embodiment includes a significantly curved portion 307 between the stand leg portion 301 and the base portion 302. In this embodiment, the key ring hole 701 may be located at an apex between the stand leg portion 301 and the curved portion 307 of the generally triangular shape. In this embodiment, only the base portion 302 may need be flat for direct contact with the connection pad 106 while the other portions may be curved for aesthetic and surface contact. The magnet 105 may be adjacent to the base portion 302 such that the kickstand 101 may be magnetically attached to the smart device (FIG. 6A) such that the stand leg portion 301 props against the surface upon which the smart device may be placed. The kickstand 101 as shown in the FIG. 7 embodiment shows the body 104 as having more of a curved shape between the stand leg portion 301 and the base portion 302 when compared to the FIG. 6 embodiment.

The magnet 105 may be configured at the base portion 302. The magnet 105 may cover the entire base portion 302. The base portion 302 may be placed adjacent to the connection pad 106. By configuring the magnet 105 to be located within the base portion 302 of the movable structure 109, the magnet 105 may exert magnetic pressure causing the body 104 to be secured to the connection pad 106. The base portion 302 may be configured such that the body 104 material may be at the exterior surface, or the base portion 302 may be configured such that the magnet 105 may be at the exterior surface.

The material which can be used to construct the kickstand 101 may be of any material appreciated by a person of ordinary skill in the art. Such materials include but are not limited to plastic, rubber, silicone, metal, or any other material. Branding, marketing, advertising, or other information may be placed on the kickstand 101. The side surfaces provide a visible surface upon which advertisers can potentially communicate information.

The kickstand props up a smart device in either a portrait or landscape orientation. When the user does not wish to use the kickstand to hold a smart device, the user can remove kickstand and transport the smart device and body independently. The kickstand may be configured in various embodiments, and some of the embodiments are discussed herein. The unique manner in which the kickstand may be designed allows a user to not be hindered or annoyed by objects attached to the back of a smart device. Smart device accessories may also be used for advertising, marketing, or other communication purposes.

Unless otherwise defined, all technical and scientific terms used herein have the same meaning as commonly understood by one of ordinary skill in the art to which this invention belongs. The terminology used in the description of the invention herein is for describing particular embodiments only and is not intended to limit the invention. As used in the description of the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties outlined in the specification and claims are approximations that may vary depending on the desired properties sought to be obtained in embodiments of the present invention. Notwithstanding that the numerical ranges and parameters setting forth the broad scope of the invention are approximations, the numerical values outlined in the specific examples are reported as precisely as possible. However, any numerical values inherently contain certain errors necessarily resulting from errors found in their respective measurements.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof.

Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts, or aspects of the inventions may be described herein as a preferred arrangement or method, such description is not intended to suggest that such feature is required or necessary unless expressly stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A kickstand for a smart device to prop up the smart device on a surface, comprising:
a body; and
a magnet attached to the body for magnetic attachment to the smart device.

2. The kickstand as recited in claim 1, wherein the magnet is encapsulated within the body.

3. The kickstand as recited in claim 2, wherein the magnet is molded into the body.

4. The kickstand as recited in claim 3, wherein the body is manufactured of a non-metallic material,

5. The kickstand as recited in claim 3, wherein the body is manufactured of a non-magnetic material.

6. The kickstand as recited in claim 3, wherein the body is generally triangular in shape.

7. The kickstand as recited in claim 6, wherein the body further comprises a curved portion between a stand leg portion and a base portion, the base portion being that which contacts the smart device.

8. The kickstand as recited in claim 7, wherein the magnet is adjacent to the base portion.

9. The kickstand as recited in claim 8, wherein the stand leg portion is curved.

10. The kickstand as recited in claim 1, further comprising a hinge such that the body is transformable between an open and a closed configuration.

11. The kickstand as recited in claim 1, wherein the magnet is magnetically attachable to a connection pad of the smart device.

12. The kickstand as recited in claim 11, wherein the connection pad is a wireless charging device that is integral with the smart device.

13. A kickstand for a smart device having a connection pad, comprising:
a base portion;
a stand leg portion;
a curved portion between the stand leg portion and the base portion; and
a magnet adjacent to the base portion for magnetic attachment to the connection pad.

14. The kickstand as recited in claim 13, wherein the connection pad is a wireless charging device that is integral with the smart device.

15. The kickstand as recited in claim 13, wherein the base portion, the stand leg portion and the curved portion form a triangular body.

16. The kickstand as recited in claim 15, wherein the magnet is encapsulated within the body.

17. The kickstand as recited in claim 15, wherein the magnet is molded into the body.
